(19) United States
(12) Patent Application Publication
(10) Pub. No.: US 2011/0108335 A1
(43) Pub. Date: May 12, 2011

(54) DRIVE HAND-CONTROL SYSTEM FOR A LAWN MOWER

(76) Inventors: Andreas Levander, Jonkoping (SE); Helena Forsberg, Jonkoping (SE); Jörgen Johansson, Jonkoping (SE)

(21) Appl. No.: 13/000,490

(22) PCT Filed: Jun. 30, 2008
(86) PCT No.: PCT/SE2008/050803

§ 371 Date: Dec. 21, 2010

(51) Int. Cl. G05G 1/04

(52) U.S. Cl. 180/19.3

(57) ABSTRACT

A drive hand-control system (6) mainly located at a lawn mower handle arrangement (5) intended for guidance of the lawn mower by an operator, the lawn mower having at least one power unit for driving at least one propulsion member and a cutting member, a drive arrangement for transmitting drive force to the at least one propulsion member and an operator presence control (7) located at the lawn mower handle arrangement (5) preferably for hand engagement by the operator, the drive hand-control system (6) comprising a drive engagement control (8) having at least two positions, where a first position disengages the drive of the at least one propulsion member and a second position engages the drive of the at least one propulsion member, and the drive engagement control (8) being switchable between the at least two positions by the operator, and the first position and the second position of the drive engagement control (8) being stable positions, which are stable without any effort from the operator, except for the effort possibly required for the hand engagement of the operator presence control (7).

### TECHNICAL FIELD

This invention relates to a drive hand-control system for a lawn mower, especially for a self-propelled lawn mower of the walk-behind type.

### BACKGROUND

Self-propelled walk-behind lawn mowers, where a power unit is used for the propulsion of the mower, are provided with a drive hand-control system of some kind. Such a system comprises means for engaging and disengaging the drive mechanism of the mower. Also, it often comprises means for adjusting the speed of the mower.

The drive engagement means as well as the speed adjustment means comprise control members, which may be provided at the rear part of the lawn mower handle together with other controls for operation of the user, such as the operator presence control (OPC), or so-called dead man control. The OPC is provided for safety reasons and ensures that the cutting element rapidly stops running if the operator loses control over the mower. The OPC is normally provided as an elongated handle, “bail arm”, which must be grasped and pressed continuously by the operator to enable the power unit and the cutting element of the mower to run.

The drive engagement control member, hereinafter referred to as the drive engagement control, often is provided as a second elongated handle, which must be pressed in the same manner as the OPC to enable the drive of the lawn mower. It may also be integrated with the speed adjustment control member, hereinafter referred to as the speed control.

The speed control can be provided in a number of different ways. For example, it may comprise a lever pivotally arranged on the handle, which must be continuously pressed by the operator during the mowing. In that case the drive engagement control is integrated with the speed control in such a way that the drive is disengaged when the lever is in one of its extreme positions, which is also a relaxed position, and engaged when the lever is moved to any other position, which is not relaxed.

The drive hand-control systems of the mowers now available on the market all have the disadvantage that it takes some effort from the operator to keep the drive in its engaged position. This is the case with the “bail arm” solution described above as well as with the speed control solutions where the drive engagement control is integrated with the speed control. Also, a disadvantage with some of them is that there are many control members to keep track of during the operation of the mower. In the case where two “bail arms” are provided for different purposes it may be hard for the operator to keep in mind which one is used for engaging the drive and which one is used for enabling the power unit to run.

As for the speed adjustment, it is often desirable to be able to adjust the speed continuously over the whole speed range as opposed to the stepwise speed adjustment provided on some lawn mowers. Several solutions have been presented for the control of such a variable speed adjustment.

Husqvarna's walk-behind lawn mower EZ Control is one example of a mower, which is provided with a variable speed control, and where the drive engagement control is integrated with the speed control. The operator controls the speed by means of a lever, which is located at the rear end of the handle and which is grasped by one hand in the same manner as a hand brake for a bicycle. By pressing the lever more or less the operator can choose a higher or lower speed respectively. And by letting go of the handle, the operator disengages the drive. However, such a speed control implies a continuous strain on the hand of the operator and prevents the operator from moving his or her hands in order to get a more comfortable grip.

Another solution for a variable speed control, where the drive engagement control is also integrated with the speed control, is disclosed in EP 1721504 B1. Here, the speed control is provided as a twist control, rotatably attached to the handle. When the operator releases his or her grip on the twist control, the control returns to its relaxed position and the drive is disengaged. However, this kind of speed control as well implies a continuous strain on one or both of the operator's hands, and therefore does not provide an ergonomic solution.

Yet another solution for a variable speed control is provided by Viking on the lawn mower MB 655V. On this mower the speed is set by means of a lever, which has a continuous range and which does not require any effort from the user to keep the set speed. However, to engage the drive the operator must grasp and press a second “bail arm”, and therefore this drive hand-control system is not an ergonomically advantageous solution.

With the disadvantages of existing solutions, there is a need on the market for an ergonomic and easy-to-use solution for controlling the drive and the speed of the mower. The operator needs a solution that admits easy control of the drive and speed and still enables him or her to move around the hands on the handle to get the grip that is most comfortable for the moment.

### SUMMARY OF THE INVENTION

It is an object of the invention to provide a drive hand-control system for a mower, which is ergonomic and allows the operator to move his or her hands along the handle of the mower. Also, it is an object of the invention to provide a drive hand-control system, where no effort is required from the operator to keep the drive in its engaged position, or to keep a set speed, and therefore does not imply a continuous strain on his or her hands.

Yet another object of the invention is to provide a drive hand-control system for a mower, which enables a better control in the driving of the mower and hence provides a safer mowing and improved workability.

According to a first aspect of the present solution there is provided a drive hand-control system mainly located at a lawn mower handle arrangement intended for guidance of the lawn mower by an operator, the lawn mower having at least one power unit for driving at least one propulsion member and a cutting member, a drive arrangement for transmitting drive force to the at least one propulsion member, and an operator presence control located at the lawn mower handle arrangement preferably for hand engagement by the operator, the drive hand-control system comprising a drive engagement control having at least two positions, where a first position disengages the drive of the at least one propulsion member and a second position engages the drive of the at least one propulsion member, and the drive engagement control being switchable between the at least two positions by the operator, and the first position and the second position of the drive engagement control being stable positions, which are stable without any effort from the operator, except for the effort possibly required for the hand engagement of the operator presence control.

Since both the first position of the drive engagement control, which disengages the drive, and the second position of the drive engagement control, which engages the drive, are stable, i.e. relaxed, positions, they are stable without any effort from the operator. Thereby, the operator does not need to provide any force to keep the drive in its disengaged or engaged position and the drive hand-control system will cause no continuous strain on his or her hands during the operation of the mower.

Also, since the second position of the drive engagement control is stable, no hand of the operator needs to be continuously occupied with the engagement of the drive. Thereby, the drive hand-control system does not restrict the operator from moving his or her hands along the handle of the mower and hence provides an ergonomic solution. This also enables the operator to drive and steer the mower in a more controlled manner and thereby contributes to a safer mowing and improved workability.

Also, an advantage of the present invention is that the number of controls that the operator needs to keep track of during the mowing is limited, since there is only one control (the OPC) that needs to be continuously engaged by the operator.

The drive engagement control may further comprise a movable lever having the two stable positions as end positions distant from each other. The two end positions of the lever may be provided in the form of an over-centre mechanism, in which the lever can be moved from any one of its stable end positions towards an over-centre position, against a force exerted by the over-centre mechanism, and further from the over-centre position towards the other of its stable end positions, supported by a force exerted by the over-centre mechanism.

The over-centre mechanism is a simple and reliable solution for obtaining the desired function with stable positions. When the operator changes the position of the lever from “on” to “off” or vice versa, the over-centre mechanism gives a clear indication that the intended position (“on” or “off”) is achieved. Also, the construction of an over-centre mechanism has much more allowance than for example a solution based on friction, where more accuracy is required.

The drive engagement control may be mounted at the handle arrangement in the vicinity of a handle portion where the operator is intended to hold his or her hands.

This placement of the drive engagement control makes it easy to use the system and the operator does not lose his or her focus on the manoeuvring of the mower when operating the control. Thereby it contributes to a safe driving of the mower.

Further, the drive engagement control may be connected to the OPC in such a way that the drive engagement control is set in its disengaging position when the operator releases the OPC into its disengaged position and that the drive engagement control can be set in its engaging position only if the OPC is in its engaged position. Thereby, the operator only needs to release the OPC in order to quickly stop the mower from driving forward. Also, it is ensured that the drive is not unintentionally engaged, when the mower is started again.

The drive hand-control system may also comprise a speed control manoeuvrable by the operator for setting the speed of the mower. In one embodiment the drive engagement control and the speed control are provided as two integrated control members. With such a solution both controls for the driving of the mower are located within the same limited area, which makes it easy for the user to find them and to manoeuvre them with one and the same hand. Also, the potential confusion is avoided, which may be experienced by the user when there are too many control members spread out over the handle. Further, the solution with integrated control members is less complicated, contains fewer parts and is therefore simpler to manufacture than a solution with two separated control members.

The speed control may be variable, and hence be set at any speed within a defined speed range. With a variable speed control the operator can choose a speed that is convenient for him or her in different situations, and thereby he or she can drive the mower in a more controlled and safer manner.

The speed control is preferably arranged to keep the speed settings without any effort from the operator of the mower. Thereby the controlling of the speed does not cause a continuous strain on his or her hands during the operation of the mower and the operator is free to move his or her hands along the handle to get a comfortable grip.

Also, the speed control may be able to keep the speed settings while the drive is disengaged and even when the power unit is shut off. In that way a kind of mechanical memory is provided for the speed settings, and the mower can easily be driven in a desired speed after for example a break in the mowing procedure.

Other advantages with the present solution will be apparent from the description of embodiments below.

### BRIEF DESCRIPTION OF THE DRAWINGS

In the following, the invention will be described in more detail with reference to preferred embodiments and the appended drawings.

FIG. 1 shows a lawn mower of the walk-behind type with a drive hand-control system in accordance with one embodiment of the present invention.

FIG. 2 shows the drive hand-control system when the drive engagement control is set in its disengaging position.

FIG. 3 shows the drive hand-control system when the drive engagement control is set in its engaging position.

FIG. 4 shows a preferred embodiment of the drive hand-control system.

FIG. 5 shows a schematic view of the drive arrangement when no cable force is applied and the drive is disengaged.

FIG. 6 shows a schematic view of the drive arrangement when a cable force is applied and the drive is engaged.

FIG. 7 shows the connection between the drive hand-control system and the operator presence control when the drive engagement control is set in its disengaging position.

FIG. 8 shows the connection between the drive hand-control system and the operator presence control when the drive engagement control is set in its engaging position.

### DETAILED DESCRIPTION OF EMBODIMENTS

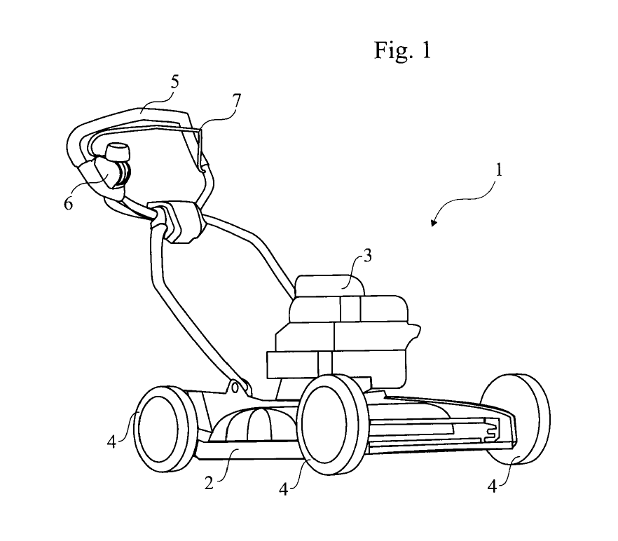

An embodiment of the invention will be described below with reference to the FIGS. 1-8.

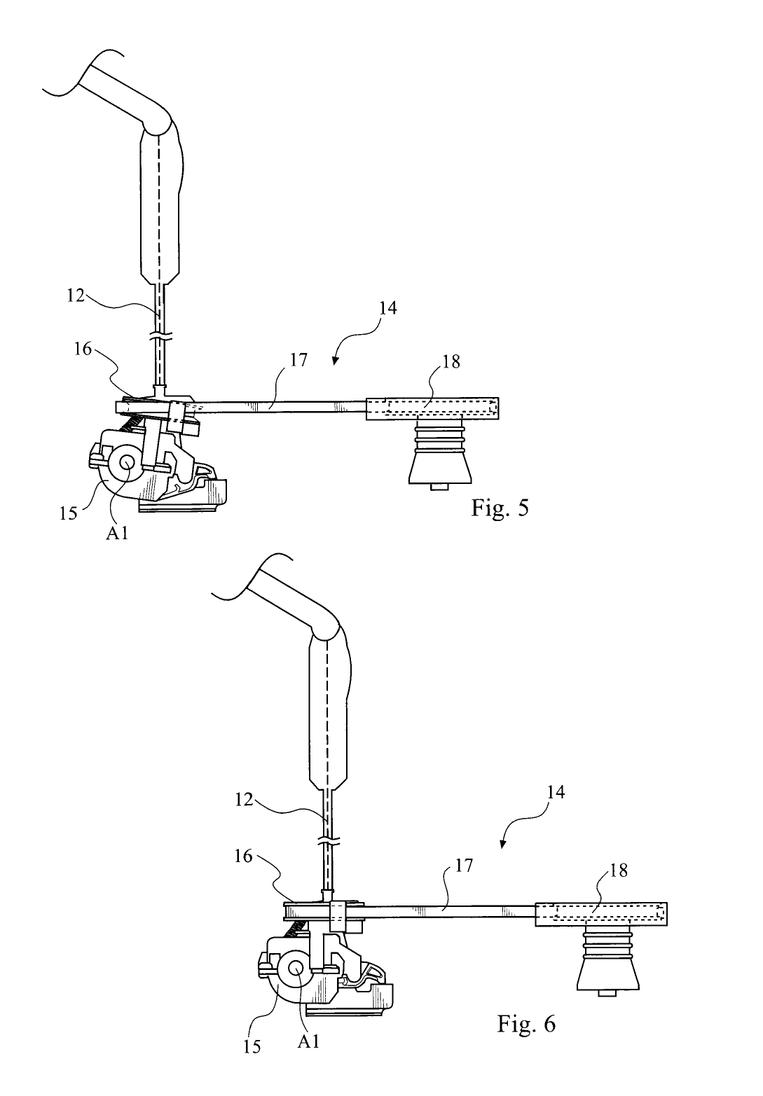

FIG. 1 shows a lawn mower 1 comprising a mower deck 2, a power unit 3, wheels 4, a handle arrangement 5, hereinafter the handle, for guidance of the lawn mower by an operator, a drive hand-control system 6 and an OPC (operator presence control) 7. The power unit 3 is arranged to generate drive force to one or more propulsion members via a drive arrangement (FIG. 5-6), and to a cutting member (not shown). The propulsion member or members can be any one or more of the wheels 4 in the illustrated embodiment, although typically the two rearmost wheels serve as driving wheels. The handle 5 extends upwardly and rearwardly from the rear portion of the mower deck 2. At the rear part of the handle 5 and in close vicinity of the hands of the operator the drive hand-control system 6 and the OPC 7 are arranged for the manipulation by the operator.

In an alternative solution the mower 1 may comprise more than one power unit 3. For example, the mower 1 may have one power unit for driving one or more propulsion members and an other power unit for driving the cutting member.

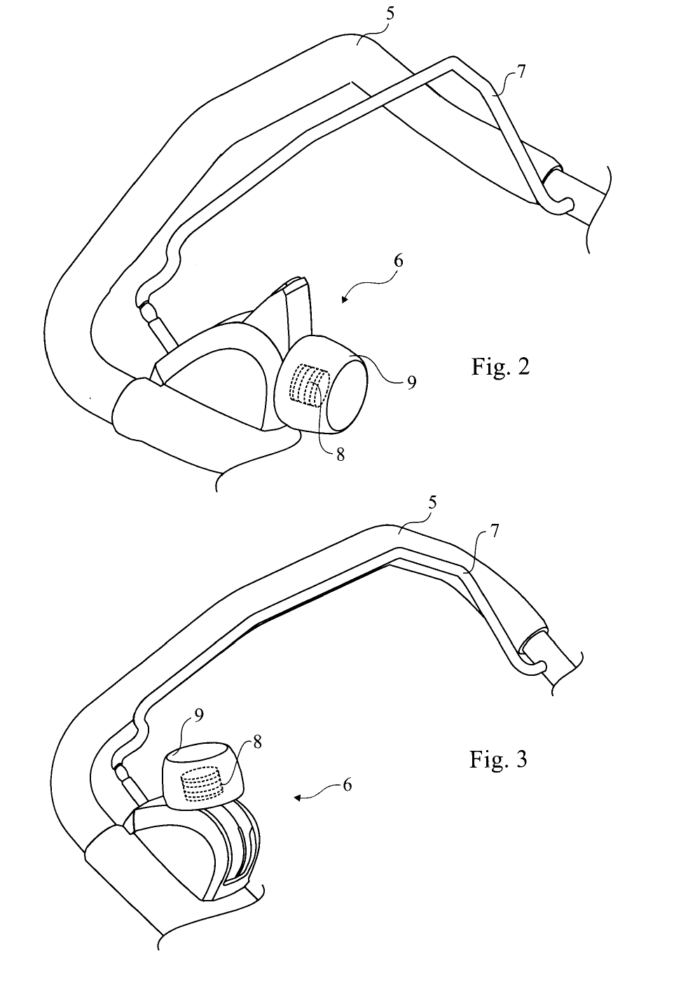

Referring now to FIGS. 2 and 3, a preferred embodiment of the drive hand-control system 6 is illustrated. The drive hand-control system 6 comprises two integrated control members for controlling the drive of the mower 1. A first one, the drive engagement control 8, is used for engaging and disengaging the drive of the mower 1, and a second one, the speed control 9, is used for adjusting the speed of the mower 1. The drive engagement control 8 is provided as a lever having two relaxed positions as end positions. The end positions hence are stable positions, and consequently no effort is required from the operator to keep the lever in its set position. In a first one of these stable end positions the drive of the driving wheels is disengaged and in a second one of the end positions the drive is engaged so that the mower 1 can move in a forward direction. In FIG. 2 the drive engagement control 8 is set in the first, disengaging position, and in FIG. 3 it is set in the second, engaging position. The speed control 9 is provided as a turning knob, which is turnable from a minimum speed to a maximum speed. In the illustrated embodiment the speed control 9 can be set at any speed within a defined range, and therefore enables a variable speed adjustment.

In an alternative embodiment of the drive hand-control system 6 the drive engagement control 8 and the speed control 9 may be provided as separate control members. For example, they may both be provided as levers arranged on the handle of the mower 1. Also, the speed control 9 may be of the kind where the speed is set at one of a limited numbers of speed levels, and therefore does not admit a variable speed adjustment.

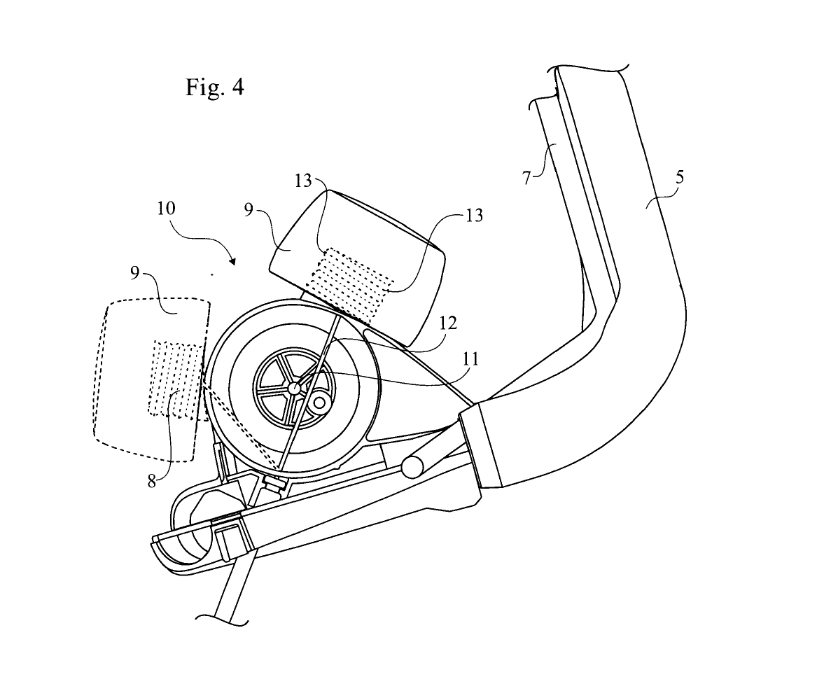

Referring now to FIG. 4, a preferred embodiment of the drive engagement control 8 is described. The two stable end positions are arranged by means of an over-centre mechanism 10, which enables the operator to move the lever of the drive engagement control 8 from one of its end positions towards an over-centre position, against a force exerted by the over-centre mechanism, and further from the over-centre position towards the other one of its end positions, supported by a force exerted by the over-centre mechanism. The force exerted by the over-centre mechanism is obtained through a wire 12 connected in one end to the drive hand-control system 6 and in the other end to a drive arrangement (FIG. 5-6). During the moving of the lever from one end position to another, the force from the wire 12 is maximal, when the wire 12 passes the over-centre point (11), i.e. when the lever is in its over-centre position. In FIG. 4 both end positions of the lever are shown. The first end position, where the drive is disengaged, is shown in dashed lines, and the second position, where the drive is engaged, is shown in unbroken lines.

In an alternative embodiment the two stable end positions of the drive engagement control 8 can be realised for example by means of a snap locking mechanism. The drive engagement control 8 can be arranged as a lever that is snapped onto the OPC 7, when this is in its engaged position. When the operator wishes to disengage the drive, he or she can either unsnap the lever from the OPC 7 or release the whole OPC 7 so that both the drive engagement and the OPC controls go into their disengaging positions.

Referring again to FIG. 4, a preferred embodiment of the speed control 9 is described. The two control members for the drive engagement control 8 and the speed control 9 are integrated in such a way that the turning knob of the speed control 9 is attached to the lever of the drive engagement control 8 by means of a screw threading 13. The wire 12 passes through the lever of the drive engagement control 8. A first end of the wire 12 is connected to the inside of the turning knob of the speed control 9 and a second end of the wire 12 is connected to the drive arrangement 14 (shown in FIGS. 5-6). As the drive engagement control 8 stands in its first, disengaging, position, no (or a very small) force is applied to the wire 12. When the drive engagement control 8 is set in its second, engaging, position, a force F is applied to the wire 12. The force F is sufficient to set the drive arrangement 14 in an engaged position. However, if the speed control is set at its minimum speed, the force F will not be sufficient for the mower to start moving forward. When the speed control knob 9 is turned from a minimum speed to a higher speed, the wire 12 is stretched and the force F applied on the wire 12 is increased, and the mower starts moving forward. In an alternative embodiment, where no speed control is provided, and therefore only one speed level is possible, the force F in the engaged position of course should be sufficient for the propulsion of the mower.

When the operator has turned the knob of the speed control 9 to a desired speed, this speed setting is kept without any effort from the operator. Therefore, no hand of the operator needs to be occupied with keeping the desired speed. Instead the operator can move his or her hands along the handle 5 for a more comfortable grip. The speed control 9 can be operated both in the disengaging and in the engaging position of the drive engagement control 8. Also, the speed settings are kept when the drive is disengaged and/or the power unit 3 is shut off. This way a kind of mechanical memory is provided for the speed settings. The speed settings are kept by the friction between the threading on the inside of the turning knob 9 and the threading on the outside of the lever 8.

Referring now to FIGS. 5 and 6, the drive arrangement 14 of the mower 1 will be briefly described. FIGS. 5 and 6 show a part of a lawn mower powertrain comprising a drive arrangement 14. A gear box assembly 15 with an input shaft and an output shaft is rotatably mounted about a horizontal axis A1. An input belt pulley 16 is arranged on the gear box input shaft and connected via a belt 17 to an engine belt pulley 18 arranged on an engine shaft. The output shaft is drivingly connected to the driving wheels. The rotational position of the gearbox assembly 15 is controllable by manoeuvring of the wire 12, which is connected to the drive hand-control system 6. In FIG. 5 no (or a very small) cable force F is applied by the drive hand-control system 6. The gearbox assembly 15, and thus the input belt pulley 16 are angled relative to a drive position. This causes the belt 17 to slip, and thus the drive is disengaged. When a sufficient cable force F is applied by the drive hand-control system 6, the gearbox assembly 15, and thus the input belt pulley 16, is rotated so that the belt 17 is tightened and the drive thus is engaged. Hence, by setting the drive engagement control 8 in its engaging position, a sufficient cable force F is applied to engage the drive. Further, by turning the speed control 9, the user can change the force F applied via the wire 12 to adjust the level of tightening of the belt 17, and thereby adjust the speed of the mower 1.

The drive arrangement 14 described above is one example of how the drive and speed can be controlled via the wire 12. However, there are a number of other possible solutions for controlling drive and speed through the wire 12.

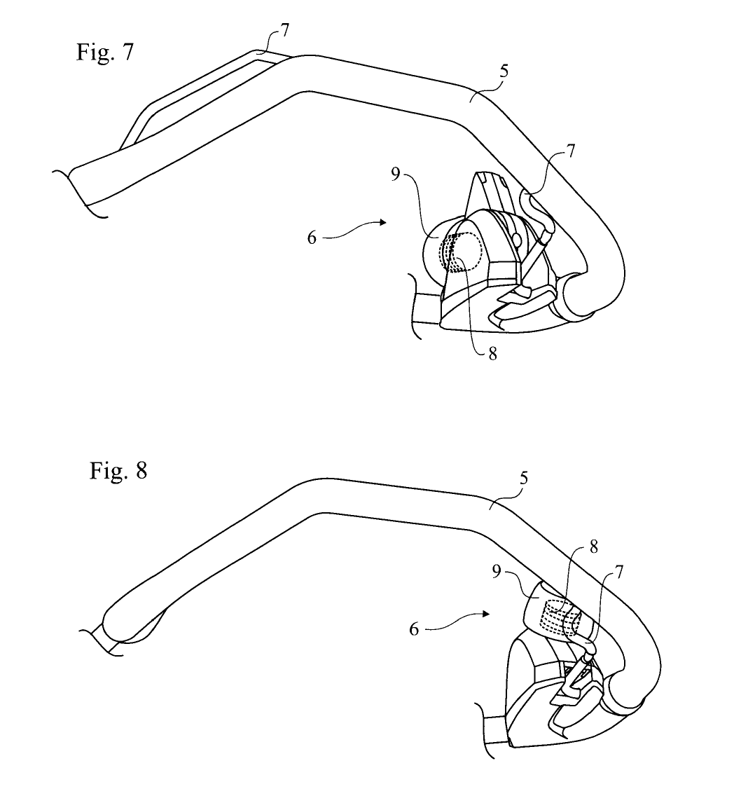

In FIGS. 7 and 8 it is illustrated how the drive hand-control system 6 may be connected to the operator presence control 7, the OPC. The OPC 7 is arranged as an elongated handle, “bail arm”, which is continuously engaged by one or both of the operator's hands for enabling the power unit 3 and the cutting element of the mower 1 to run. As soon as the operator releases the OPC 7 into its disengaged position, the power unit 3 stops running and the cutting member is rapidly stopped. Hence, with an OPC 7 according to this embodiment a certain effort is needed from the operator to keep the OPC 7 in its engaged position. In the present invention the drive engagement control 8 is connected to the OPC 7 in such a way that the drive engagement control 8 is set in its disengaging position when the operator releases the OPC 7 into its disengaged position. The connection is arranged at one end of the OPC 7 in such a way that the OPC 7 must be activated, i.e. pressed into its engaged position, before the drive engagement control 8 can be set in its engaging position. FIG. 7 shows the drive engagement control 8 and the OPC 7 in their disengaging positions and FIG. 8 shows both controls in their engaging positions.

In an alternative embodiment the operator presence control may be provided in a form that does not require any effort from the operator. For example, the mower 1 may be provided with an electrical system that senses the presence and absence of the operator's hands respectively. For the power unit 3 to be able to run, the system must sense at least one hand of the operator at the handle arrangement 5.

It is to be understood that the invention has been described above with regard to a few example embodiments. However, as is readily appreciated by a person skilled in the art, other embodiments than the ones disclosed above are equally possible within the scope of the invention, as defined by the appended patent claims.

What is claimed is:

1. A drive hand-control system mainly located at a lawn mower handle arrangement intended for guidance of the lawn mower by an operator, the lawn mower having at least one power unit for driving at least one propulsion member and a cutting member, a drive arrangement for transmitting drive force to the at least one propulsion member, and an operator presence control located at the lawn mower handle arrangement preferably for hand engagement by the operator,
the drive hand-control system comprising:
a drive engagement control having at least two positions, where a first position disengages the drive of the at least one propulsion member and a second position engages the drive of the at least one propulsion member,
and the drive engagement control being switchable between the at least two positions by the operator,
characterised in that the first position and the second position of the drive engagement control are stable positions, which are stable without any effort from the operator.

2. A drive hand-control system according to claim 1,
wherein the drive engagement control comprises a movable lever having the two stable positions as end positions distant from each other.

3. A drive hand-control system according to claim 2, wherein the two end positions are provided in the form of an over-centre mechanism,
in which the lever can be moved from any one of its stable end positions towards an over-centre position, against a force exerted by the over-centre mechanism, and further from the over-centre position towards the other of its stable end positions, supported by a force exerted by the over-centre mechanism.

4. A drive hand-control system according to claim 1,
wherein the drive engagement control is mounted at the handle arrangement in the vicinity of a handle portion where the operator is intended to hold his or her hands.

5. A drive hand-control system according to claim 1,
wherein the drive engagement control is connected to the operator presence control in such a way that the drive engagement control is set in its disengaging position when the operator releases the operator presence control into its disengaged position and that the drive engagement control can be set in its engaging position only if the operator presence control is in its engaged position, in which case a certain effort is needed from the operator to keep the OPC in its engaged position.

6. A drive hand-control system according to claim 1,
comprising a speed control manoeuvrable by the operator for setting the speed of the mower.

7. A drive hand-control system according to claim 6,
wherein the drive engagement control and the speed control are provided as two integrated control members.

8. A drive hand-control system according to claim 6,
wherein the speed control is arranged as a turning knob incorporated in the lever of the drive engagement control, and wherein the speed control is turnable from a minimum speed to a maximum speed both in the disengaging position and the engaging position of the drive engagement control.

9. A drive hand-control system according to claim 6,
wherein the drive engagement control and the speed control are provided as two separate control members.

10. A drive hand-control system according to claim 9,
wherein the speed control is provided as a lever, arranged to be engaged and set at a desired speed by the operator.

11. A drive hand-control system according to claim 6,
wherein the speed control is a variable speed control, and hence can be set at any speed within a defined speed range.

12. A drive hand-control system according to claim 6,
wherein the speed control is arranged to keep its speed settings without any effort from the operator of the mower.

13. A drive hand-control system according to claim 12,
wherein the speed control is able to keep the speed settings while the drive is disengaged and/or the power unit is shut off.

14. A drive hand-control system according to claim 1,
being connectable to a disengageable drive arrangement via a wire, said drive arrangement comprising a gear box assembly having at least one input shaft and at least one output shaft, said output shaft being drivingly connectable to the at least one propulsion member, said gear box assembly being mountable for rotation about a first axis (A1) under the action of a cable force acting at the gear box assembly via said wire, wherein a rotational position of said gear box assembly about said first axis (A1) is controllable by said drive hand-control system via said wire.

15. A self-propelled lawn mower comprising a drive hand-control system according to claim 1.
